(19) United States
(12) Patent Application Publication
(10) Pub. No.: US 2005/0179512 A1
(43) Pub. Date: Aug. 18, 2005

(54) MRI SYSTEM WITH LIQUID COOLED RF SPACE

(75) Inventors: Daniel J. Weyers, Brookfield, WI (US); Anton M. Linz, Mukwongago, WI (US); Graeme C. McKinnon, Hartland, WI (US); Ed B. Boskamp, Menomonee Falls, WI (US); Roman I. Dachniwskyj, Pewaukee, WI (US); Michael B. Sellers, Florence, SC (US); Anthony Manton, Florence, SC (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY COMPANY, LLC, Waukesha, WI (US)

(21) Appl. No.: 10/708,164

(22) Filed: Feb. 12, 2004

(51) Int. Cl. H01F 5/00

(52) U.S. Cl. 335/300

(57) ABSTRACT

A radio frequency space cooling system (11) for a magnetic resonance imager system (10) includes a thermal energy transfer device (78). The energy transfer device (78) reduces the temperature of a cooling fluid (86) within the cooling system (11). A cooling element (82) is coupled to the energy transfer device (78) and extends along a patient bore (15) between a radio frequency shield (22) and a radio frequency coil (20) of the magnetic resonance imager system (10). The cooling element (82) has a channel (90) for passage of the cooling fluid (86).

### BACKGROUND OF INVENTION

The present invention relates to cooling techniques for magnetic resonance imaging systems. More particularly, the present invention relates to a system for reducing the thermal energy transfer from a gradient coil assembly to an RF coil and a patient bore.

Currently, Magnetic Resonance Imager (MRI) systems have included a superconducting magnet that generates a temporally constant primary magnetic field. The superconducting magnet is used in conjunction with a magnetic gradient coil assembly, which is sequentially pulsed, to create a sequence of controlled gradients in the static magnetic field during an MRI data gathering sequence. The controlled gradients are effectuated throughout a patient imaging volume (patient bore), which is coupled to one or more radio frequency (RF) coils or antennae. The RF coils are located between the magnetic gradient coil assembly and the patient bore.

As a part of a typical MRI sequence, RF signals of suitable frequencies are transmitted into the patient bore. Nuclear magnetic resonance (nMR) responsive RF signals are received from the patient bore via the RF coils. Information encoded within the frequency and phase parameters of the received RF signals, by the use of an RF circuit, is processed to form visual images. These visual images correspond to the distribution of nMR nuclei within a cross-section or volume of the patient within the patient bore.

There is a continuous desire to increase the scan rates of an MRI system, which in turn increases power requirements of the gradient coil assemblies contained therein. The increase in power consumption by the gradient coil assemblies increases temperatures within the patient volume. A thermal radiation shield is commonly utilized between the gradient coil assembly and the RF coil assembly to reduce the heat transfer therebetween and into the patient volume. RF shields perform as thermal generators in that they are generally good conductors and are capable of supporting current from the gradient and RF fields.

With the ever-increasing power densities within the gradient coil assembly comes increasing inability of the thermal radiation shield to prevent heating of the RF antennae and the patient bore. Also, for patient comfort and safety there exist temperature operating and rise requirements, as well as overall surface temperature limitations. One such requirement is that of maintaining the patient bore at a temperature below 41° C.

Additionally, when an electrically conductive shield is used between the RF coil and the magnetic gradient coil assembly degradation of the resonant electrical properties of the RF circuit and possibly the fidelity of the nMR signals can occur. An electrically conductive shield may also cause the production of detrimental eddy currents. As eddy currents produce their own magnetic fields, the magnetic fields produced by these eddy currents can cause interference with the MRI imaging process.

When an infrared reflective shield is used between the RF coil and the RF shield interference of RF wavelengths of interest during an MRI operation can result. The interference with the RF wavelengths of interest can degrade MRI imaging.

In combination with the aforesaid, MRI systems that have a metallic outer surface on the patient bore may also have RF interference with the nMR signals caused by these metallic surfaces.

Thus, there exists a need for an improved MRI cooling system that minimizes thermal energy transfer from the gradient coil assembly to the RF coil assembly and patient bore without degradation of nMR signals.

### SUMMARY OF INVENTION

The present invention provides a radio frequency space cooling system for a magnetic resonance imager system. The cooling system includes a thermal energy transfer device. The energy transfer device reduces the temperature of a cooling fluid within the cooling system. A cooling element is coupled to the energy transfer device and extends along a patient bore between a radio frequency shield and a radio frequency coil of the magnetic resonance imager system. The cooling element has a channel for passage of the cooling fluid.

The embodiments of the present invention provide several advantages. One such advantage is the provision of active cooling elements within the RF space of an MRI system. The cooling elements prevent thermal energy transfer between a gradient coil assembly and a RF coil of the MRI system. The cooling elements can also be used to remove heat generated in the gradient coil assembly and the RF shield.

Another advantage provided by an embodiment of the present invention, is the provision of conductive elements arranged in a serpentine like pattern along a patient bore, thereby providing cooling while shielding nMR signals, which are sensitive to the circulation of cooling fluids therein.

The above-stated advantages allow for increased MRI scanning speeds with reduced operating temperatures, especially within spaces between the gradient coil assembly and the patient bore of a MRI system. The reduced patient bore temperature provides improved patient comfort and safety.

The present invention itself, together with attendant advantages, will be best understood by reference to the following detailed description, taken in conjunction with the accompanying figures.

### BRIEF DESCRIPTION OF DRAWINGS

For a more complete understanding of this invention reference should now be had to the embodiments illustrated in greater detail in the accompanying figures and described below by way of examples of the invention wherein:

FIG. 1 is a block diagrammatic view of a magnetic resonance imager (MRI) system utilizing an active RF space cooling system in accordance with an embodiment of the present invention;

FIG. 2 is a cross-sectional view of an RF space in accordance with an embodiment of the present invention; and

FIG. 3 is a side exterior view of a RF coil assembly of FIG. 1 with multiple active cooling elements coupled thereon and in accordance with an embodiment of the present invention.

### DETAILED DESCRIPTION

In the following figures the same reference numerals will be used to refer to the same components. While the present invention is described with respect to a system for reducing thermal energy transfer from a gradient coil assembly to a RF coil and a patient bore, the present invention may be adapted and applied to various systems including: magnetic resonance imager (MRI) systems, magnetic resonance spectroscopy systems, and other systems that require gradient magnetic fields or radio frequency (RF) fields.

In the following description, various operating parameters and components are described for one constructed embodiment. These specific parameters and components are included as examples and are not meant to be limiting.

Also, in the following description the term “RF space” refers the space within an MRI system between and including an RF shield and a magnetic RF coil assembly. The RF space may also include other RF related components, such as a dielectric former, insulation layers, or other RF components known in the art.

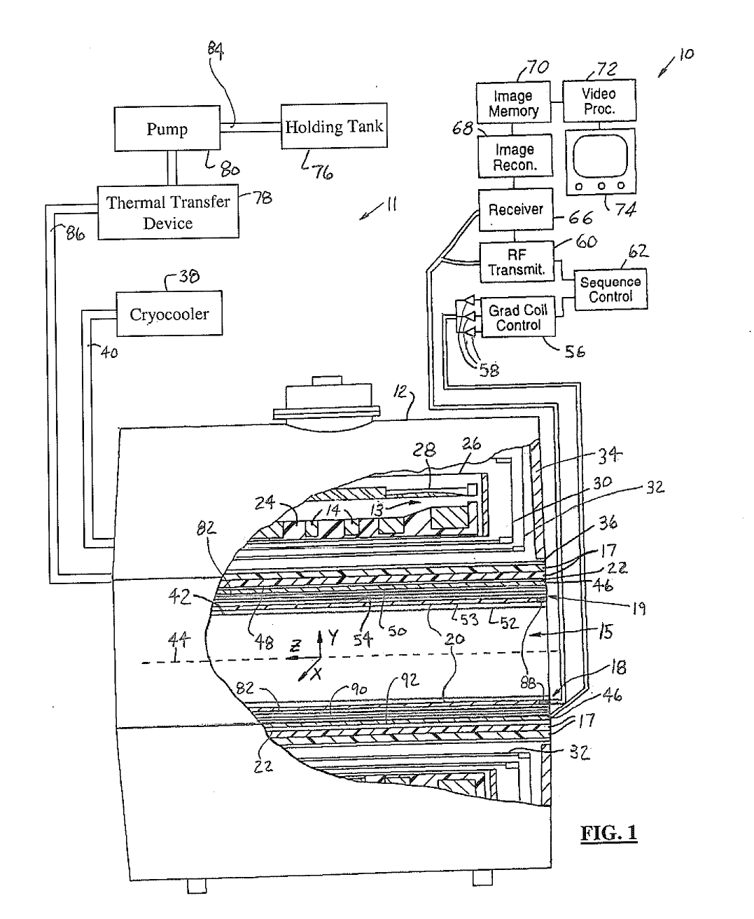

Referring now to FIG. 1, a block diagrammatic view of a magnetic resonance imager (MRI) system 10 utilizing an active RF space cooling system 11 in accordance with an embodiment of the present invention is shown. The MRI system 10 includes a static magnet structure 12 (a cylindrical structure) including a superconducting magnet 13 having a plurality of superconducting magnetic coils 14, which generate a temporally constant magnetic field along a longitudinal or z-axis of a central or patient bore 15. The magnet structure 12 also includes a magnetic gradient coil assembly 17 and an RF coil assembly 18, which generate a gradient field and an RF field, respectively, within the patient bore 15. The RF coil assembly 18 is located within an RF space 19 and includes a primary RF coil 20 and a RF shield 22. The RF shield 22 resides between the gradient coil assembly 17 or at least a portion thereof and the RF coil assembly 18. The RF shield 22 and the cooling system 11 extract thermal energy from the gradient coil assembly 17 and prevent the transfer of thermal energy from the gradient coil assembly 17 to the patient bore 15 and the RF coil assembly 18.

The superconducting magnet coils 14 are supported by a superconducting magnet support structure former 24 and are received in a toroidal helium vessel 26. A main magnetic field shield coil assembly 28 generates a magnetic field that opposes the field generated by the superconducting magnet coils 14. A first thermal shield 30 surrounds the helium vessel 26 to reduce “boil-off”. A second thermal shield 32 may surround the first thermal shield 30. Both the first thermal shield 30 and the second thermal shield 32 may be cooled by mechanical refrigeration.

A toroidal vacuum vessel 34 encases the first thermal shield 30 and the second thermal shield 32. The toroidal vacuum vessel 34 comprises a cylindrical member 36 that surrounds the patient bore 15 and extends parallel to the z-axis. Both vessels 26 and 34 may be coupled to a cryocooler 38, as shown, or some other cooling mechanism for maintaining a desired temperature therein. A first cooling fluid 40 is circulated between the cryocooler 38 and the vessels 26 and 34.

On an exterior side 42 of the patient bore 15, which is a longitudinal side farthest away from a center 44 of the patient bore 15, and inside the member 36 is the gradient coil assembly 17. The gradient coil assembly 17 may include a cylindrical dielectric former 46, which resides on a first interior side 48 of the gradient coil assembly 17. The RF shield 22 may be applied on a second interior side 50 of the dielectric former 46 or may be coupled elsewhere and within the gradient coil assembly 17, as known in the art.

One or more insulation layers 52 are coupled to an interior side 53 and/or to an exterior side 54 of the RF coil 20. The insulation layers 52 aid in the prevention of heat transfer into the patient bore 15. Although only one insulation layer is shown, any number of insulation layers may be utilized. The insulation layers 52, for example, may be formed of a fiberglass material.

The gradient coil assembly 17 is coupled to a gradient coil controller 56 via a series of current pulse generators 58. The RF coil 20 is connected to an RF transmitter 60, which is connected to the sequence controller 62. The sequence controller 62 controls the current pulse generators 58 via the gradient coil controller 56. The RF transmitter 60 in conjunction with the sequence controller 62 generate pulses of radio frequency signals for exciting and manipulating magnetic resonance in selected dipoles of a portion of the subject within the patient bore 15.

A radio frequency receiver 66 is connected with the RF coil 20 for demodulating magnetic resonance signals emanating from an examined portion of a subject within the patient bore 15. The radio frequency receiver 66 is connected to an image reconstruction apparatus 68, which reconstructs the received magnetic resonance signals into an electronic image representation that is stored in an image memory 70. The stored electronic images in the image memory 70 are converted by a video processor 72 into an appropriate format for display on a video monitor 74.

The cooling system 11 includes a holding tank 76, a thermal transfer device 78, a pump 80, and multiple active cooling elements 82. The holding tank 76 contains a second cooling fluid 84, which may be circulated through the energy transfer device 78 and the cooling elements 82, via the pump 80. The holding tank 76 may be external to the structure 12 as shown or may be incorporated into the structure 12. In operation, the cooling elements 82 absorb the thermal energy within the RF space 19, which is transferred into a third cooling fluid 86 passing therethrough and then extracted from the second cooling fluid 84 by the energy transfer device 78.

The energy transfer device 78 may also be external to, as shown, or may be internal to the structure 12. The energy transfer device 78 may be in the form of a cryocooler or a heat exchanger, as shown. Although the cryocooler 38 and the energy transfer device 78 are shown as separate entities, they may be incorporated into a single unit and be in the form of a single cryocooler or a single heat exchanger. The cryocooler 38 and the energy transfer device 78 may be shared by the vessels 26 and 34 and the cooling elements 82. The second cooling fluid 84 may be circulated between the holding tank 76 and the energy transfer device 78. The third cooling fluid 86 may be circulated between the energy transfer device 78 and the cooling elements 82. In this configuration, thermal energy is transferred from the third cooling fluid 86 to the second cooling fluid 84.

The cooling fluids 40, 84, and 86 may be in the form of distilled water, ethylene glycol, propylene glycol, perfluorocarbins, a combination thereof, or may be in the form of some other suitable coolant known in the art.

The cooling elements 82 extend across the patient bore 15 parallel to the z-axis and generally over the end-rings 88 of the RF coil 20. The cooling elements 82 have channels 90 for passage of the third cooling fluid 86 therein. Any number and length of cooling elements 82 may be utilized in the cooling system 11. The cooling elements 82 may be coupled on the RF coil assembly 18, on the second interior side 50, or on a third interior side 92 of the RF shield 22.

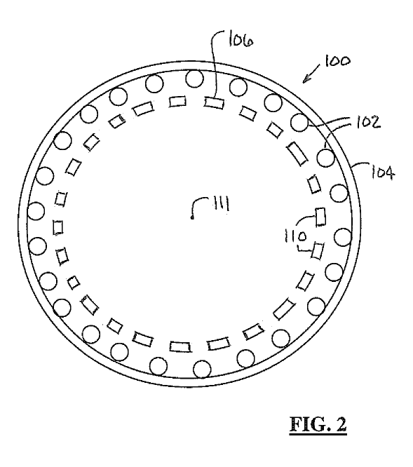

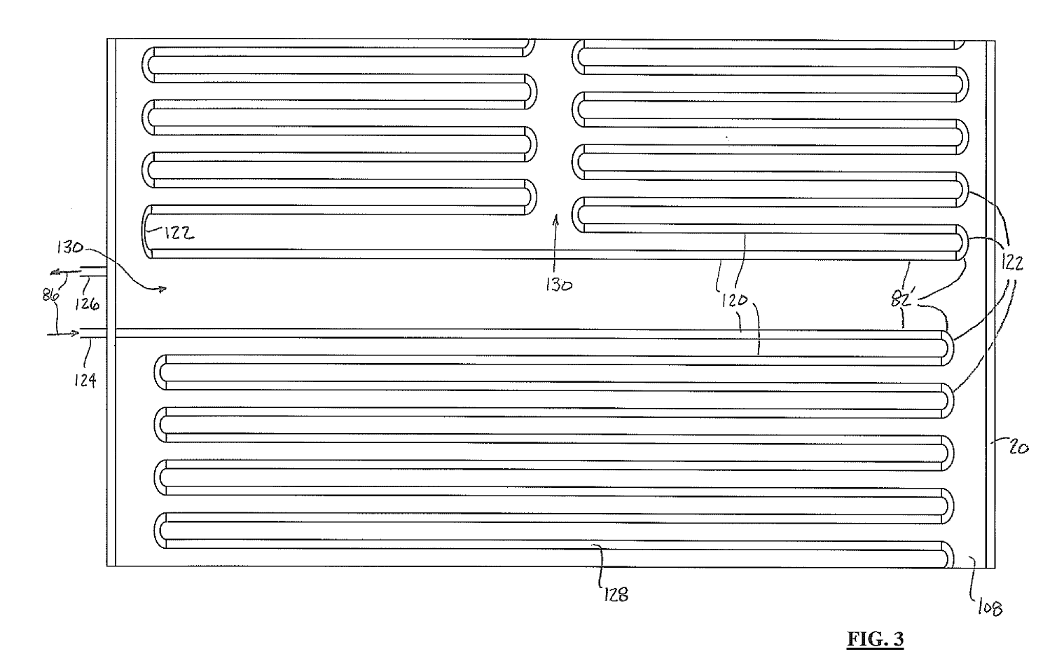

Referring now to FIG. 2, a cross-sectional view of an RF space 100 in accordance with an embodiment of the present invention is shown. Cooling elements 102 are shown as being coupled within the RF space 100 between an RF shield 104 and an RF coil 106. Although the cooling elements are shown as being directly coupled to the RF shield 104, they may be coupled directly to the RF coil 106 or to an insulation layer coupled over the RF coil 106, such as the insulation layer 108 shown in FIG. 3. The cooling elements 102 extend across and parallel to the patient bore 15 and parallel to the rungs 110 of the RF coil 106. The cooling elements 102 can be offset from the rungs 110 relative to the center 111. This offset provides for increased performance of the RF coil 106, due to the rungs 110 not being radially lined-up with the cooling elements 102.

Referring now to FIG. 3, a side exterior view of the RF coil assembly 18 with the cooling elements 82″ coupled thereon is shown in accordance with an embodiment of the present invention. The cooling elements 82″ include multiple extension members 120 and coupling members 122. The cooling elements 82″ are coupled directly on the insulation shield 108 covering the RF coil 20. The cooling elements 82″ are coupled in series and extend across the patient bore 15 in a serpentine like pattern, such that there is a single input 124 and a single output 126 with a single continuous fluid path or channel 128 therebetween. This stated configuration of the cooling elements 82″ aids in shielding the gradient and RF fields from the flow of the third cooling fluid 86 and also aids in the prevention of induction within the stated generated fields. The use of a single fluid path also provides component and connection efficiency. Although a single fluid path having a single input and a single output is shown, multiple fluid paths with multiple inputs and outputs may be utilized.

The extension members 120 extend across a majority of the patient bore 15 to maximize shielding, minimize affects of fluid flow on the nMR signals, and maximize cooling of the RF space 19 and the patient bore 15. The extension members 120 are formed of a conductive material, such as copper or stainless steel, and spaced apart to shield and also prevent coolant flow therein from affecting the nMR signals and creating image artifacts. The extension members 120 are coupled together via the coupling members 122.

The coupling member 122 may be ‘U’-shaped, as shown. The coupling members 122 may be of various size and shape. The input 124 and output 126 are nonconductive to prevent the input 124 from being conductive with the output 126 or from causing a closed-loop path for eddy currents to flow. Spaces may be provided between the cooling elements 82′, such as spaces 130, for drive cables (not shown) or other electronic components or controls.

The present invention provides a cooling system for actively cooling the RF space of an MRI system. The cooling system efficiently cools the RF space and in turn maintains the temperature within a patient bore of the MRI system below a predetermined temperature level. The cooling system provides such cooling with minimal affect on gradient and RF fields generated within the MRI system. The present invention in providing such cooling increases service life of MRI system components and increases patient and customer satisfaction.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A radio frequency space cooling system for a magnetic resonance imager system comprising:
a thermal energy transfer device reducing temperature of a cooling fluid within the radio frequency space cooling system; and
at least one cooling element coupled to said thermal energy transfer device and extending along a patient bore between a radio frequency shield and a radio frequency coil of the magnetic resonance imager system, said at least one cooling element having at least one channel for passage of said cooling fluid.

2. A system as in claim 1 wherein said thermal energy transfer device is at least one of a cryocooler and a heat exchanger.

3. A system as in claim 1 wherein said at least one cooling element comprises a plurality of cooling elements that are coupled in series.

4. A system as in claim 1 wherein said at least one cooling element comprises a plurality of cooling elements that are coupled in a serpentinely manner.

5. A system as in claim 1 wherein said at least one cooling element is formed at least partially of a conductive material.

6. A system as in claim 1 wherein said at least one cooling element is formed at least partially of a conductive material selected from at least one of copper and stainless steel.

7. A system as in claim 1 wherein said at least one cooling element comprises:
a plurality of extension members; and
a plurality of coupling members.

8. A system as in claim 7 wherein at least one of said plurality of coupling members are non-conductive.

9. A system as in claim 7 wherein at least one of said plurality of coupling members are U-shaped.

10. A system as in claim 1 wherein said at least one cooling element comprises:
an input; and
an output non-conductively coupled to said input.

11. A system as in claim 1 wherein said at least one cooling element extends across a significant length and along a z-axis of said patient bore.

12. A system as in claim 1 wherein said at least one cooling element extends parallel to at least one rung of said radio frequency coil.

13. A system as in claim 1 wherein said at least one cooling element extends over end-rings of said radio frequency coil.

14. A system as in claim 1 wherein said at least one cooling element comprises a single continuous channel.

15. A system as in claim 1 wherein said at least one cooling element is radially offset from at least one rung of said radio frequency coil.

16. A magnetic resonance imager system comprising:
a gradient coil assembly;
a radio frequency shield;
a radio frequency (RF) coil; and
at least a portion of an active cooling system residing between said radio frequency shield and said radio frequency coil, said active cooling system preventing thermal energy transfer between said gradient coil assembly and said radio frequency coil.

17. A system as in claim 16 wherein said active cooling system comprises at least one cooling element coupled between said radio frequency shield and said radio frequency coil and extending along a patient bore of the magnetic resonance imager system.

18. A system as in claim 17 wherein said at least one cooling element comprise at least one channel for passage of a cooling fluid.

19. A system as in claim 17 wherein said at least one element is coupled on said radio frequency coil.

20. A system as in claim 17 further comprising at least one insulation layer coupled between said radio frequency coil and said at least one element.

21. A system as in claim 17 wherein said radio frequency shield is coupled into said gradient coil assembly.

22. A magnetic resonance imager system comprising:
a gradient coil assembly;
a radio frequency shield;
a radio frequency (RF) coil; and
at least cooling element residing between said radio frequency shield and said radio frequency coil, said at least one cooling element having at least one channel for passage of a cooling fluid.

23. A system as in claim 22 wherein said at least one cooling element comprises a plurality of cooling elements coupled in a serpentine manner, said plurality of cooling elements extend parallel to and along a z-axis of a patient bore of the magnetic resonance imager system.
